(19) United States
(12) Patent Application Publication
(10) Pub. No.: US 2018/0159823 A1
(43) Pub. Date: Jun. 7, 2018

(54) NETWORK ADDRESS TRANSLATION SERVER AND NETWORK ADDRESS TRANSLATION METHOD THEREOF

(71) Applicant: Institute For Information Industry, Taipei (TW)

(72) Inventors: Whai-En CHEN, Taipei City (TW); Li-Yao TSENG, Taipei City (TW)

(21) Appl. No.: 15/371,166

(22) Filed: Dec. 6, 2016

(30) Foreign Application Priority Data
Dec. 5, 2016 (TW) 105140085

(51) Int. Cl. H04L 29/12; H04L 29/06

(52) U.S. Cl. CPC H04L 61/2521; H04L 65/1006; H04L 65/608; H04L 65/1069

(57) ABSTRACT

A NAT server and a NAT method thereof are provided. The NAT server receives a SIP message including private network RTP information from a user equipment. The NAT server modifies the private network RTP information of the SIP message into public network RTP information and creates in the mapping table a mapping record of the private network RTP information and the public network RTP information. The NAT server transmits the SIP message to a SIP server. The NAT server receives another SIP message from the SIP server, and determines that the public network RTP information of the another SIP message corresponds to the private network RTP information according to the mapping record. The NAT server modifies the public network RTP information of the another SIP message into the private network RTP information and transmits the another SIP message to another user equipment of the private network.

### PRIORITY

This application claims priority to Taiwan Patent Application No. 105140085 filed on Dec. 5, 2016, which is hereby incorporated by reference in its entirety.

### FIELD

The present invention relates to a network address translation (NAT) server and a NAT method thereof. More particularly, the NAT server and the NAT method thereof of the present invention are used to assist user equipments of a same private network in communicating with each other in real time.

### BACKGROUND

The Session Initiation Protocol (SIP) is a signal control protocol for the network application layer, and is mainly used to create, modify and terminate various related communication services, a primary one of which is the Real-time Transport Protocol (RTP).

In other words, in order to create an RTP communication between two parties (i.e., the caller and the callee), each of the two parties needs to know an Internet Protocol (IP) address and a connection port used by the other party in performing RTP communication. This is accomplished by means of SIP before performing RTP communication.

However, it is uncertain whether or not a public network connection is assigned by the NAT server to the RTP communication service when RTP communication service related packets of SIP pass through the NAT server, so there is a problem that the packet may not be correctly transmitted. In the conventional network technology, a SIP server (e.g., an RTP proxy server) having an application layer gateway (ALG) function is mainly used for translation of network packets so that RTP communication service network packets of SIP of UEs can still be correctly forwarded after passing through the NAT server.

However, when two UEs are located in a local area network (LAN) of a same NAT server in the aforesaid architecture and one of the UEs is to create RTP communication service of SIP with the other UE, related network packets of the RTP communication service still needs to be transmitted by the one UE to the SIP server via the NAT server, then transmitted by the SIP server back to the NAT server, and finally transmitted by the NAT server to the other UE although the two UEs are located within a same LAN. In this process, in addition to the NAT server, the SIP server also needs to translate the related packets.

Therefore, the packet transmission efficiency of RTP communication services of SIP is relatively low when the two UEs are located within a LAN of a same NAT server, and this also represents a burden to the backend SIP server. Accordingly, joint efforts have to be made in the art to overcome these shortcomings.

### SUMMARY

The disclosure includes a network address translation (NAT) method for a NAT server, comprising: (a) enabling the NAT server to receive a first Session Initiation Protocol (SIP) invitation message from a first user equipment (UE) of a private network, wherein the first SIP invitation message comprises first private network communication information of the first UE, first identification information of a second UE and first private network Real-time Transport Protocol (RTP) information; (b) enabling the NAT server to modify the first private network communication information of the first SIP invitation message into first public network communication information according to a first mapping record of a mapping table.

Furthermore, the NAT method further may comprise: (c) enabling the NAT server to modify the first private network RTP information of the first SIP invitation message into first public network RTP information and create in the mapping table a second mapping record indicating that the first private network RTP information corresponds to the first public network RTP information; (d) enabling the NAT server to transmit the SIP invitation message to a SIP server of the public network according to connection port information of the first SIP invitation message after the step (c) so that the SIP server accesses registration information of the second UE according to first identification information of the SIP invitation message, modifies the first identification information of the first SIP invitation message into second identification information according to the registration information, and then transmits the first SIP invitation message to the NAT server according to the second identification information.

Furthermore, the NAT method further may comprise: (e) enabling the NAT server to receive the first SIP invitation message from the SIP server, and determine that the first public network RTP information of the first SIP invitation message corresponds to the first private network RTP information according to the second mapping record; (f) enabling the NAT server to modify the first public network RTP information of the first SIP invitation message into the first private network RTP information according to the second mapping record and modify the second identification information of the first SIP invitation message into third identification information of the second UE according to a third mapping record of the mapping table after the step (e); (g) enabling the NAT server to transmit the first SIP invitation message to the second UE of the private network according to the third identification information after the step (f) so that the second UE responds to the first UE according to the first private network RTP information.

The disclosure also includes a NAT server comprising a memory, a transceiving interface, and a processing unit. The memory stores a mapping table. The transceiving interface is configured to receive a first SIP invitation message from a first UE of a private network, wherein the first SIP invitation message comprises first private network communication information of the first UE, first identification information of a second UE and first private network RTP information.

The processing unit can be configured to: modify the first private network communication information of the first SIP invitation message into first public network communication information according to a first mapping record of the mapping table; modify the first private network RTP information of the first SIP invitation message into first public network RTP information and create in the mapping table a second mapping record indicating that the first private network RTP information corresponds to the first public network RTP information; transmit the SIP invitation message to a SIP server of the public network through the transceiving interface according to connection port information of the first SIP invitation message so that the SIP server accesses registration information of the second UE according to first identification information of the SIP invitation message, modifies the first identification information of the first SIP invitation message into second identification information according to the registration information, and then transmits the first SIP invitation message to the NAT server according to the second identification information.

Furthermore, the processing unit can be further configured to: receive the first SIP invitation message through the transceiving interface from the SIP server, and then determine that the first public network RTP information of the first SIP invitation message corresponds to the first private network RTP information according to the second mapping record; modify the first public network RTP information of the first SIP invitation message into the first private network RTP information according to the second mapping record and modify the second identification information of the first SIP invitation message into third identification information of the second UE according to a third mapping record of the mapping table; transmit the first SIP invitation message to the second UE of the private network through the transceiving interface according to the third identification information so that the second UE responds to the first UE according to the first private network RTP information.

The disclosure further includes a NAT method for a NAT server, comprising: (a) enabling the NAT server to receive a first SIP invitation message from a first UE of a private network, wherein the first SIP invitation message comprises first private network RTP information and first public network identification information of a second UE; (b) enabling the NAT server to determine that the first public network identification information is consistent with a first registration record of a equipment registration table; (c) enabling the NAT server to modify the first public network identification information of the first SIP invitation message into first private network identification information according to the first registration record based on the result of the step (b); (d) enabling the NAT server to transmit the first SIP invitation message to the second UE according to the first private network identification information so that the second UE responds to the first UE according to the first private network RTP information.

The disclosure additionally includes a NAT server comprising a memory, a transceiving interface, and a processing unit. The memory stores an equipment registration table. The transceiving interface is configured to receive a first SIP invitation message from a first UE of a private network, wherein the first SIP invitation message comprises first private network RTP information and first public network RTP information of a second UE. The processing unit is configured to: determine that the first public network identification information is consistent with a first registration record of the equipment registration table; modify the first public network identification information of the first SIP invitation message into first private network identification information according to the first registration record; and transmit the first SIP invitation message to the second UE through the transceiving interface according to the first private network identification information so that the second UE responds to the first UE according to the first private network RTP information.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating operations of a NAT server according to a first embodiment of the present invention;

FIG. 1B is a block diagram of the NAT server according to the first embodiment of the present invention;

FIG. 2 is a schematic view illustrating operations of a NAT server according to a second embodiment of the present invention;

FIG. 3A to FIG. 3B are schematic views illustrating detailed operations of a NAT server according to a third embodiment of the present invention;

FIG. 3C is a schematic view of a mapping table according to the third embodiment of the present invention;

FIG. 4A is a schematic view illustrating operations of a NAT server according to a fourth embodiment of the present invention;

FIG. 4B is a block diagram of the NAT server according to the fourth embodiment of the present invention;

FIG. 5 is a schematic view illustrating operations of a NAT server according to a fifth embodiment of the present invention;

FIG. 6A to FIG. 6B are schematic views illustrating detailed operations of a NAT server according to a sixth embodiment of the present invention;

FIG. 6C is a schematic view of an equipment registration table according to a sixth embodiment of the present invention;

FIG. 7 is a flowchart diagram of a NAT method according to a seventh embodiment of the present invention;

FIG. 8A to FIG. 8C are flowchart diagrams of a NAT method according to an eighth embodiment of the present invention;

FIG. 9 is a flowchart diagram of a NAT method according to a ninth embodiment of the present invention; and

FIG. 10 is a flowchart diagram of a NAT method according to a tenth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

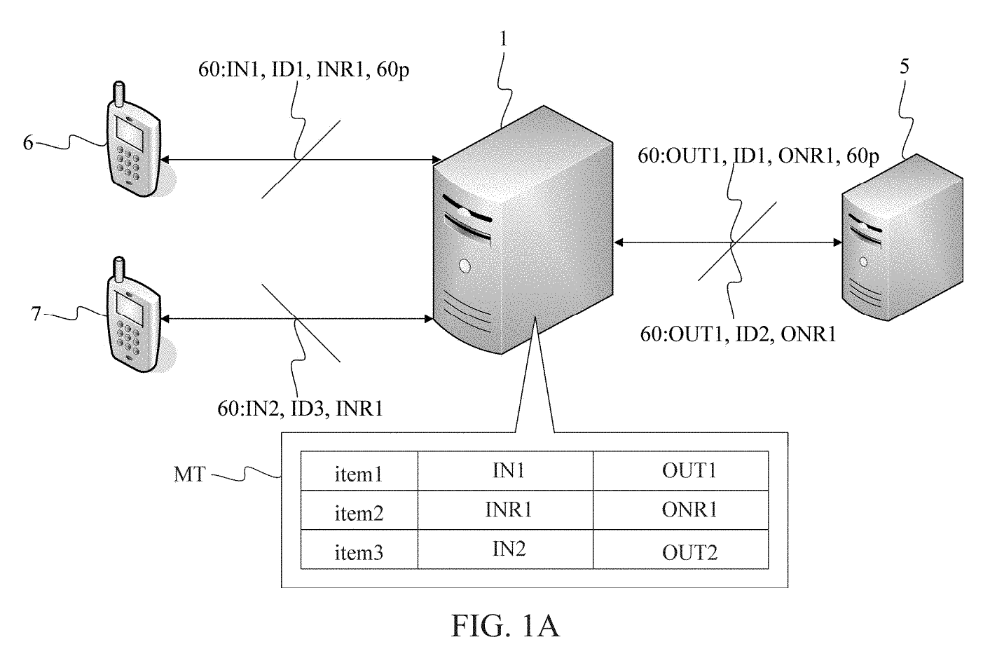

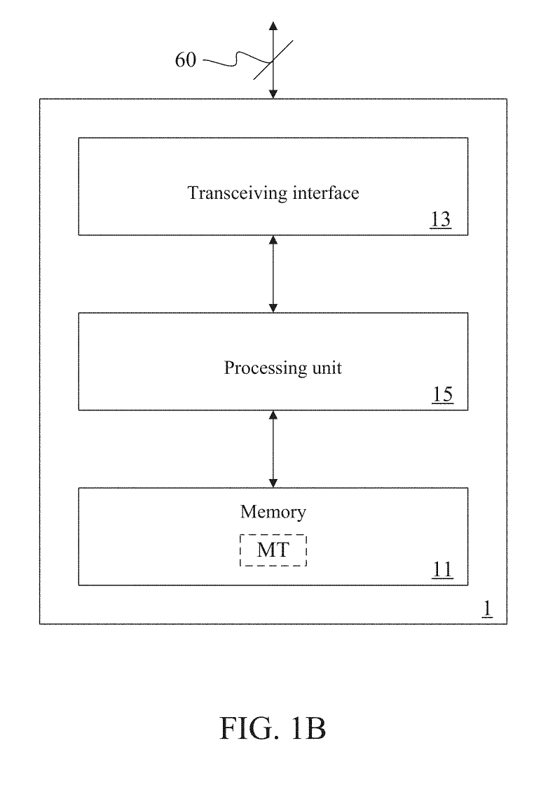

Please refer to FIG. 1A to FIG. 1B. FIG. 1A is a schematic view illustrating operations of a NAT server 1 according to a first embodiment of the present invention, and FIG. 1B is a block diagram of the NAT server 1 according to the first embodiment of the present invention. The NAT server 1 comprises a memory 11, a transceiving interface 13 and a processing unit 15. The memory 11 stores a mapping table MT. These elements are electrically connected with each other, and interactions therebetween will be further described hereinbelow.

First, when a first UE 6 in a private network of the NAT server 1 is to request a second UE 7 to create a Session Initiation Protocol (SIP), the first UE 6 transmits a first SIP invitation message 60 by using first identification information ID1 of the second UE 7. The first SIP invitation message 60 comprises first private network communication information IN1 of the first UE 6, first identification information ID1 and first private network Real-time Transport Protocol (RTP) information INR1. Because the first identification information ID1 is destined to a public network, the first SIP invitation message 60 is transmitted first to the NAT server 1.

Then when the first SIP invitation message 60 is received by the transceiving interface 13 of the NAT server 1, the first SIP invitation message 60 is adjusted by the processing unit 15 first. Specifically, because a first mapping record item1 of the mapping table MT mainly records correspondence relationship between the first private network communication information IN1 of the first UE 6 and first public network communication information OUT1 (i.e., the correspondence relationship between an address used by the first UE 6 in the private network and an address used by the NAT server 1 in the public network). Therefore, the processing unit 15 of the NAT server 1 may modify the first private network communication information IN1 of the first SIP invitation message 60 into the first public network communication information OUT1 to facilitate routing of the message in the public network.

Next, the processing unit 15 of the NAT server 1 modifies the first private network RTP information INR1 of the first SIP invitation message into first public network RTP information ONR1 according to the public network transmission information (e.g., the network address of the NAT server 1) of the NAT server 1 itself, and creates in the mapping table MT a second mapping record item2 indicating that the first private network RTP information INR1 corresponds to the first public network RTP information ONR1.

Upon completing the corresponding adjustment, the processing unit 15 of the NAT server 1 transmits the SIP invitation message 60 to a SIP server 5 of the public network via the transceiving unit 13 according to connection port information 60p of the first SIP invitation message 60. If there is related registration information of the second UE 7 in the SIP server 5, the SIP server 5 may access registration information (not shown) of the second UE 7 according to the first identification information ID1 of the SIP invitation message 60. The registration information indicates that the second UE 7 is located within the private network where the NAT server 1 is located.

Accordingly, the SIP server 5 may modify the first identification information ID1 of the first SIP invitation message 60 into second identification information ID2 related to the NAT server 1 according to the registration information. Then, the SIP server 5 transmits the first SIP invitation message 60 to the NAT server 1 directly according to the second identification information ID2 without performing translation on any real-time communication packets.

The first SIP invitation message 60 received by the transceiving interface 13 from the SIP server 5 is viewed as a common SIP message by the NAT server 1 at the beginning. Then, the processing unit 15 determines that the first public network RTP information ONR1 of the first SIP invitation message 60 corresponds to the first private network RTP information INR 1 according to the second mapping record item2 and, from this, learns that the first SIP invitation message 60 was previously transmitted by a UE (i.e., the first UE 6) in the private network of the NAT server 1. Accordingly, the processing unit 15 modifies the first public network RTP information ONR1 of the first SIP invitation message 60 back into the first private network RTP information INR1 according to the second mapping record item2.

Because a third mapping record item3 of the mapping table MT mainly records correspondence relationship between second private network information IN2 of the second UE 7 and second public network information OUT2 (i.e., the correspondence relationship between the address used by the second UE 7 in the private network and the address used by the NAT server 1 in the public network), the processing unit 15 of the NAT server 1 can then modify the second identification information ID2 of the first SIP invitation message 60 into third identification information ID3 of the second UE 7. Thereby, the processing unit 15 of the NAT server 1 can transmit the first SIP invitation message 60 to the second UE 7 of the private network according to the third identification information ID3 so that the second UE 7 responds to the first UE 6 according to the first private network RTP information INR.

It shall be particularly appreciated that, the second mapping record item2 becomes useless once the first public network RTP information ONR1 of the first SIP invitation message 60 has been modified back into the first private network RTP information INR1 by the processing unit 15 of the NAT server 1 according to the second mapping record item2, so the second mapping record item2 may be removed from the mapping table MT to prevent possible errors caused in subsequent determinations.

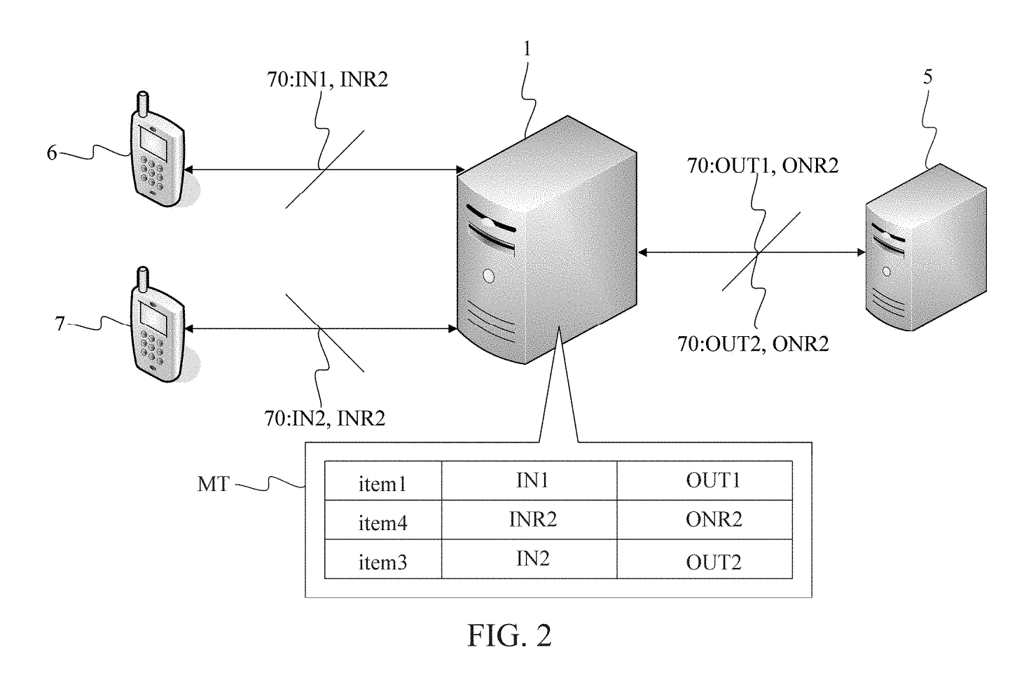

Please refer to FIG. 2, which is a schematic view illustrating operations of the NAT server 1 according to a second embodiment of the present invention. The second embodiment is similar to the first embodiment in network architecture, so elements represented by the same symbols have the same functions and will not be described again herein. The second embodiment is mainly intended to further describe how the second UE responds to the first UE via the NAT server according to the first private network RTP information.

After the second UE 7 has received the first SIP invitation message 60 and agreed to create the communication, the second UE 7 needs to inform the first UE 6 of related information used by SIP of the second UE 7. Specifically, the second UE 7 transmits a first SIP response message 70 to an NAT server 1 after receiving the first SIP invitation message 60. The first SIP response message 70 comprises the second private network communication information IN2 of the second UE and second private network RTP information INR2.

Then after the first SIP response message 70 is received by the transceiving interface 13 of the NAT server 1 from the second UE 7, the processing unit 15 modifies the second private network communication information IN2 of the first SIP response message into the second public network identification information OUT2 according to the third mapping record item3 of the mapping table MT. On the other hand, the processing unit 15 modifies the second private network RTP information INR2 of the first SIP response message 70 into second public network RTP information ONR2, and creates in the mapping table MT a fourth mapping record item4 indicating that the second private network RTP information corresponds to the second public network RTP information ONR2.

Then, the transceiving interface 13 routes the first SIP response message 70 back to the SIP server 5 along the original routing path. Likewise, the SIP server 5 routes the first SIP response message 70 back to the NAT server 1 to which the first UE 6 belongs along the original routing path.

After the first SIP response message 70 is received by the transceiving interface 13 of the NAT server 1 from the SIP server 5, the processing unit 15 determines that the second public network RTP information ONR2 of the first SIP response message 70 corresponds to the second private network RTP information INR2 according to the fourth mapping record item4, and modifies the second public network RTP information ONR2 of the first SIP response message 70 into the second private network RTP information INR2 according to the fourth mapping record item4.

Then, the processing unit 15 transmits the first SIP response message 70 back to the first UE 6 of the private network via the transceiving interface 13 so that the first UE 6 returns an acknowledgement to the second UE 7 through the same step as what described above. Thereby, the first UE 6 and the second UE 7 can perform real-time communication with each other according to the first private network RTP information INR1 and the second private network RTP information INR2.

Similarly, the fourth mapping record item4 becomes useless once the second public network RTP information ONR2 of the first SIP invitation message 70 has been modified back into the second private network RTP information INR2 by the processing unit 15 of the NAT server 1 according to the fourth mapping record item4, so the fourth mapping record item4 may be removed from the mapping table MT to prevent possible errors caused in subsequent determinations.

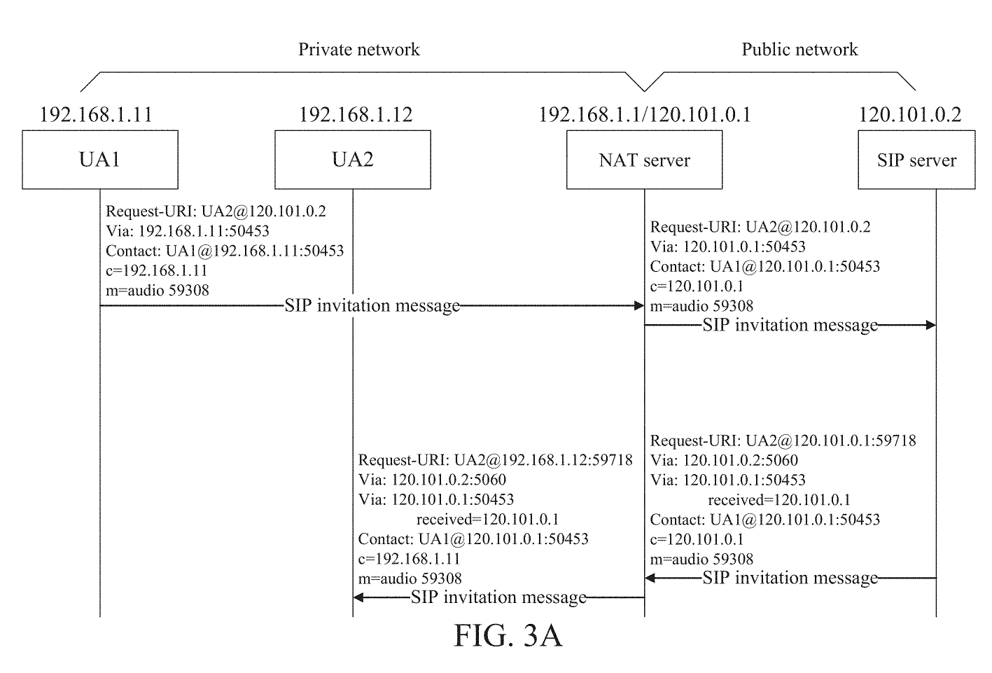

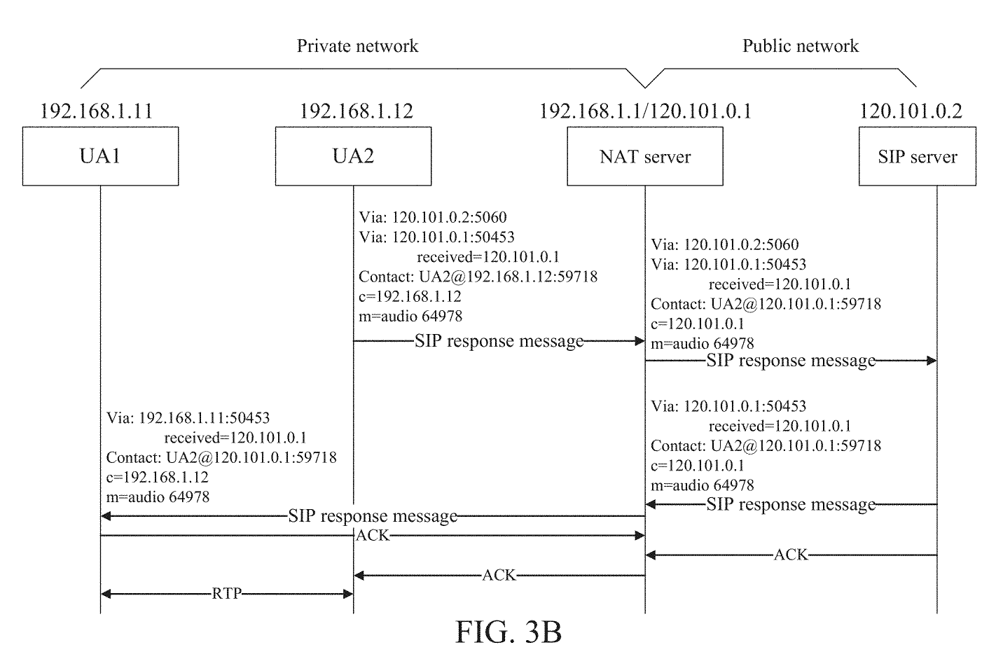

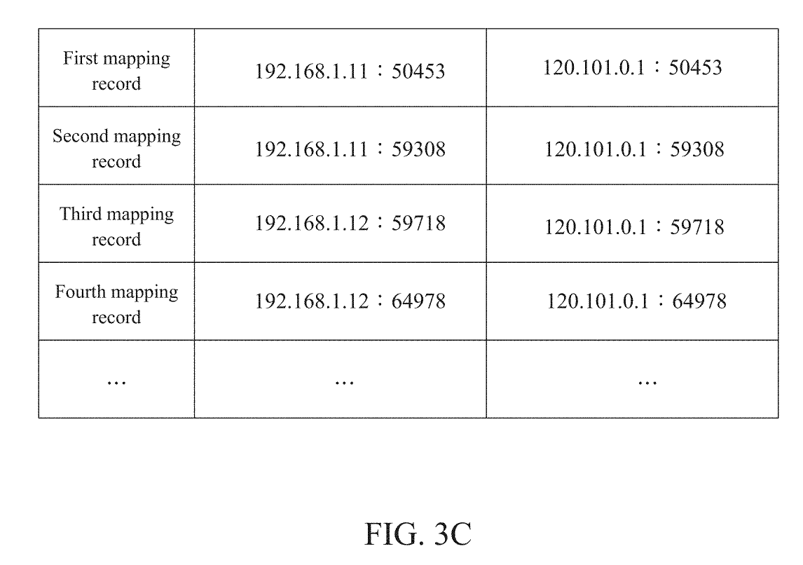

Please refer to FIG. 3A to 3C. FIG. 3A to FIG. 3B are schematic views illustrating detailed operations of a NAT server according to a third embodiment of the present invention, and FIG. 3C is a schematic view of a mapping table according to the third embodiment of the present invention. The third embodiment is similar to the previous embodiments in network architecture, so hardware elements identical to those of the previous embodiments will not be described again herein. The third embodiment is mainly intended to illustrate the operation process.

First when a first UE UA1 in a private network of the NAT server is to request a second UE UA2 in an unknown network to create SIP, the first UE UA1 transmits a SIP invitation message by using first identification information (UA2@120.101.0.2) of the second UE UA2. The SIP invitation message comprises first private network communication information (192.168.1.11:50453) of the first UE UA1, first identification information (UA2@ 120.101.0.2) and first private network RTP information (c:192.168.1.11 and m:audio 59308). Because the first identification information is destined to the public network, the SIP invitation message is transmitted to the NAT server first.

It shall be particularly appreciated that, in the SIP invitation message, the RTP information related field c mainly defines the connection information, the m field mainly defines a media type (e.g., the following five types: audio, video, text, application, message) and connection port No. used for connection. This can be readily known by those skilled in the art from related documents, so it will not be further described herein.

Then when the SIP invitation message is received, the first SIP invitation message is adjusted by the NAT server first. In the third embodiment, because a first mapping record of the mapping table mainly records correspondence relationship between the first private network communication information (192.168.1.11:50453) of the first UE UA1 and first public network communication information (120.101.0.1:50453:50453), the NAT server may modify the first private network communication information (192.168.1.11:50453) of the SIP invitation message into first public network communication information (120.101.0.1:50453:50453) to facilitate routing of the message in the public network.

Next, the NAT server modifies the first private network RTP information (c:192.168.1.11 and m:audio 59308) of the SIP invitation message into first public network RTP information (c:120.101.0.1 and m:audio 59308) according to the public network transmission information (i.e., the network address 120.101.0.1 of the NAT server for the public network) of the NAT server itself, and creates in the mapping table MT a second mapping record indicating that the first private network RTP information (c:192.168.1.11 and m:audio 59308) corresponds to the first public network RTP information (c:120.101.0.1 and m:audio 59308).

Upon completing the corresponding adjustment, the NAT server transmits the SIP invitation message to a SIP server of the public network according to connection port information (e.g., the connection port Port:5060 commonly used for SIP service) of the SIP invitation message. If there is related registration information of the second UE in the SIP server, the SIP server may access registration information of the second UE according to the first identification information (UA2@ 120.101.0.2) of the SIP invitation message. The registration information indicates that the second UE is located within the private network where the NAT server is located.

Accordingly, the SIP server may modify the first identification information (UA2@ 120.101.0.2) of the SIP invitation message into second identification information (UA2@ 120.101.0.1:59718) related to the NAT server according to the registration information. Then, the SIP server transmits the IP invitation message to the NAT server directly according to the second identification information (UA2@ 120.101.0.1:59718) without performing translation on any real-time communication packets.

The SIP invitation message received by the NAT server from the SIP server is viewed as a common SIP message by the NAT server at the beginning. The NAT server determines whether information of the SIP invitation message is consistent with an item in the mapping table. In this exemplary example, the NAT server determines that the first public network RTP information (c:120.101.0.1 and m:audio 59308) of the SIP invitation message corresponds to the first private network RTP information (c:192.168.1.11 and m:audio 59308) according to the second mapping record and, from this, learns that the SIP invitation message was previously transmitted by the first UE UA1 in the private network of the NAT server. Accordingly, the NAT server modifies the first public network RTP information (c:120.101.0.1 and m:audio 59308) of the SIP invitation message back into the first private network RTP information (c:192.168.1.11 and m:audio 59308) according to the second mapping record and removes the second mapping record.

Because a third mapping record of the mapping table records correspondence relationship between second private network information (192.168.1.12:59718) of the second UE UA2 and second public network information (120.101.0.1:59718), the NAT server can then modify the second identification information (UA2@ 120.101.0.1:59718) of the SIP invitation message into third identification information (UA2@ 192.168.1.12:59718). Thereby, the NAT server can transmit the SIP invitation message to the second UE UA2 according to the third identification information.

Then the second UE UA2 having received the SIP invitation message transmits a SIP response message to the NAT server. The SIP response message comprises second private network communication information (192.168.1.12:59718) and second private network RTP information (c:192.168.1.12 and m:audio 64978) of the second UE.

Next, the NAT server receiving the SIP response message from the second UE modifies the second private network communication information (192.168.1.12:59718) of the SIP response information into the second public network identification information (120.101.0.1:59718) according to the third mapping record of the mapping table. On the other hand, the NAT server modifies the second private network RTP information (c:192.168.1.12 and m:audio 64978) into second public network RTP information (c:120.101.0.1 and m:audio 64978) and creates in the mapping table a fourth mapping record indicating that the second private network RTP information corresponds to the second public network RTP information.

Thereafter, the NAT server routes the SIP response message back to the SIP server along the original routing path. Likewise, the SIP server routes the SIP response message back to the NAT server to which the first UE UA1 belongs along the original routing path. It shall be particularly appreciated that, as will be readily understood by those skilled in the art from the attached drawings, the routing path is recorded in the Via header of the SIP packet, and because the present invention mainly focuses on address translation instead of routing path processing, use of the Via header will not be further described herein.

Next, after receiving the SIP response message from the SIP server and determining that the second public network RTP information (c:120.101.0.1 and m:audio 64978) of the SIP response message corresponds to the second private network RTP information (c:192.168.1.12 and m:audio 64978) according to the fourth mapping record, the NAT server modifies the second public network RTP information (c:120.101.0.1 and m:audio 64978) of the SIP response message into the second private network RTP information (c:192.168.1.12 and m:audio 64978) according to the fourth mapping record. Likewise, the fourth mapping record is removed.

Afterwards, the NAT server transmits the SIP response message back to the first UE UA1 of the private network so that the first UE UA1 returns an acknowledgement to the second UE UA2 through the same step as what described above. Thereby, the first UE UA1 and the second UE UA2 can perform real-time communication with each other according to the first private network RTP information (c:192.168.1.11 and m:audio 59308) and the second private network RTP information (c:192.168.1.12 and m:audio 64978).

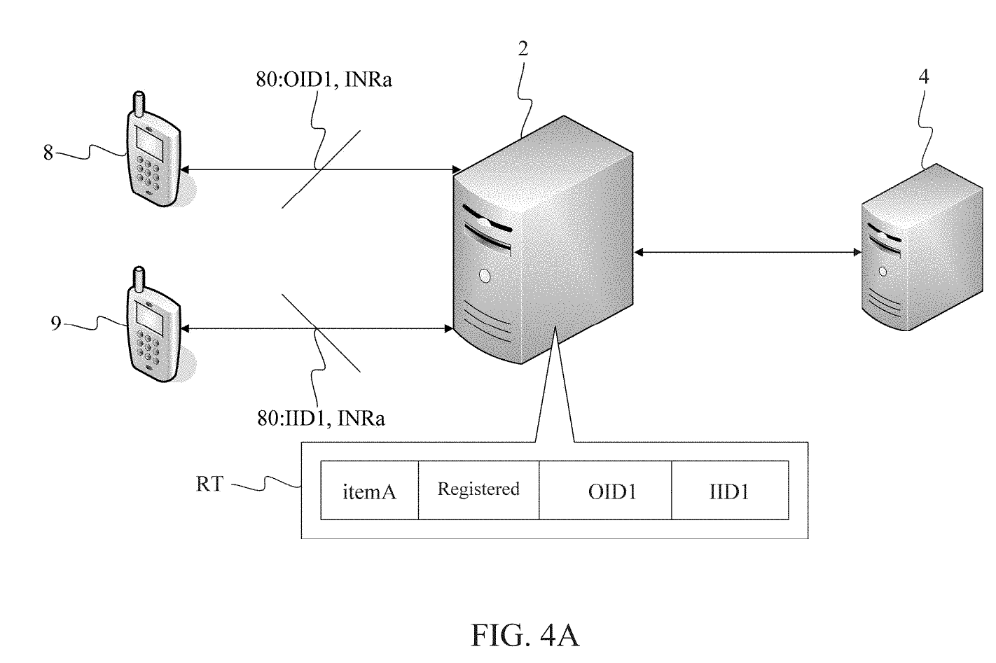

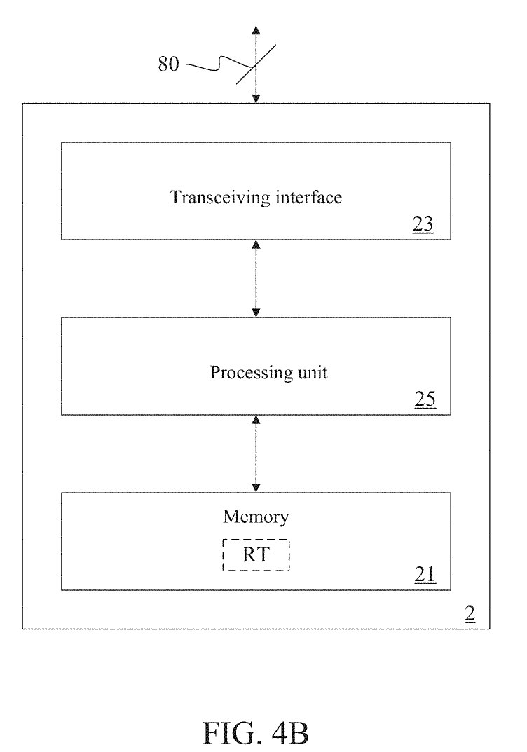

Please refer to FIG. 4A to FIG. 4B. FIG. 4A is a schematic view illustrating operations of a NAT server 2 according to a fourth embodiment of the present invention, and FIG. 4B is a block diagram of the NAT server 2 according to the fourth embodiment of the present invention. The NAT server 2 comprises a memory 21, a transceiving interface 23 and a processing unit 25. The memory 21 stores an equipment registration table RT. These elements are electrically connected with each other, and interactions therebetween will be further described hereinbelow.

First, when a first UE 8 in a private network of the NAT server 2 is to request a second UE 9 to create a SIP, the first UE 8 transmits a first SIP invitation message 80 by using first public network identification information OID1 of the second UE 9. The first SIP invitation message 80 comprises first private network RTP information INRa and the first public network communication information OID1 of the second UE.

Because the equipment registration table RT mainly records registration relationships between equipments in the private network and a SIP server 4, the processing unit 25 may determine whether the first public network identification information OID1 is consistent with a registration record of the equipment registration table RT directly according to the equipment registration table RT after the first SIP invitation message 80 is received by the transceiving interface 23. In this embodiment, the processing unit 25 determines that the first public network identification information OID1 is consistent with a first registration record itemA of the equipment registration table RT.

The NAT server 2 may then learn from the first registration record itemA that the second UE 9 to which the first UE 8 is to connect is located within a same private network as the first UE 8. Accordingly, the processing unit 25 modifies the first public network identification information OID1 into first private network identification information IID1 according to the first registration record itemA, and transmits the first SIP invitation message 80 to the second UE 9 via the transceiving interface 23 according to the first private network identification information IID1 so that the second UE 9 responds to the first UE 8 according to the first private network RTP information INRa.

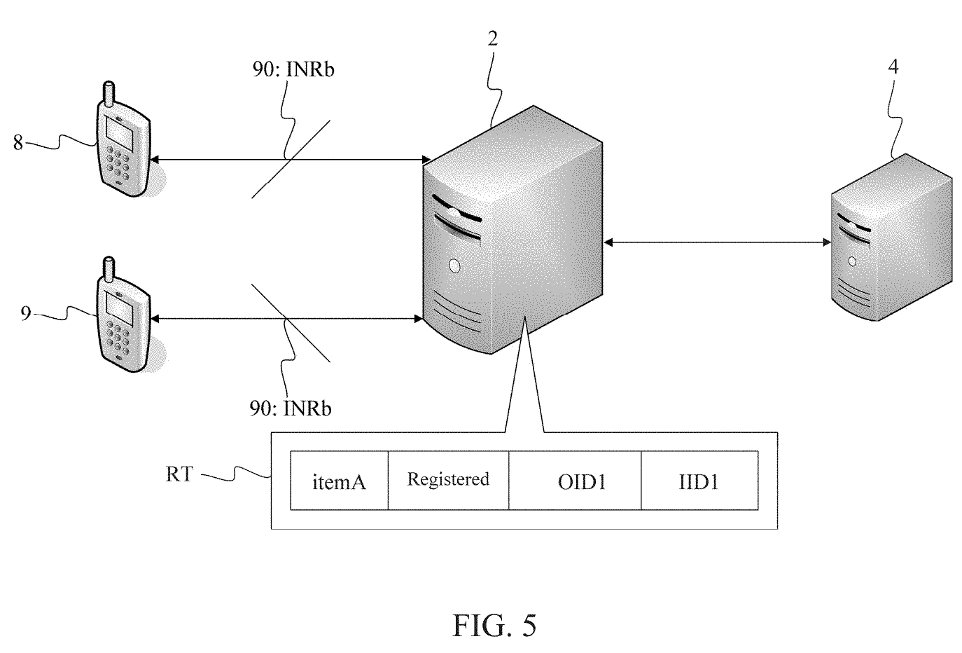

Please refer to FIG. 5, which is a schematic view illustrating operations of a NAT server 2 according to a fifth embodiment of the present invention. The fifth embodiment is similar to the fourth embodiment in network architecture, so elements represented by the same symbols have the same functions and will not be described again herein. The fifth embodiment is mainly intended to further describe how the second UE responds to the first UE via the NAT server according to the first private network RTP information.

After the second UE 9 has received the first SIP invitation message 80 and agreed to create the communication, the second UE 9 needs to inform the first UE 8 of related information used by SIP of the second UE 9. Specifically, the second UE 9 transmits a first SIP response message 90 to the NAT server 2 after receiving the first SIP invitation message 80. The first SIP response message 90 comprises second private network communication information INRb.

Then after the first SIP response message 90 is received by the transceiving interface 23 of the NAT server 2, the processing unit 25 transmits the first SIP response message 90 to the first UE 8 directly via the transceiving interface 23 so that the first UE 8 returns an acknowledgement to the second UE and performs real-time communication with the second UE 9 according to the first private network RTP information INRa and the second private network RTP information INRb.

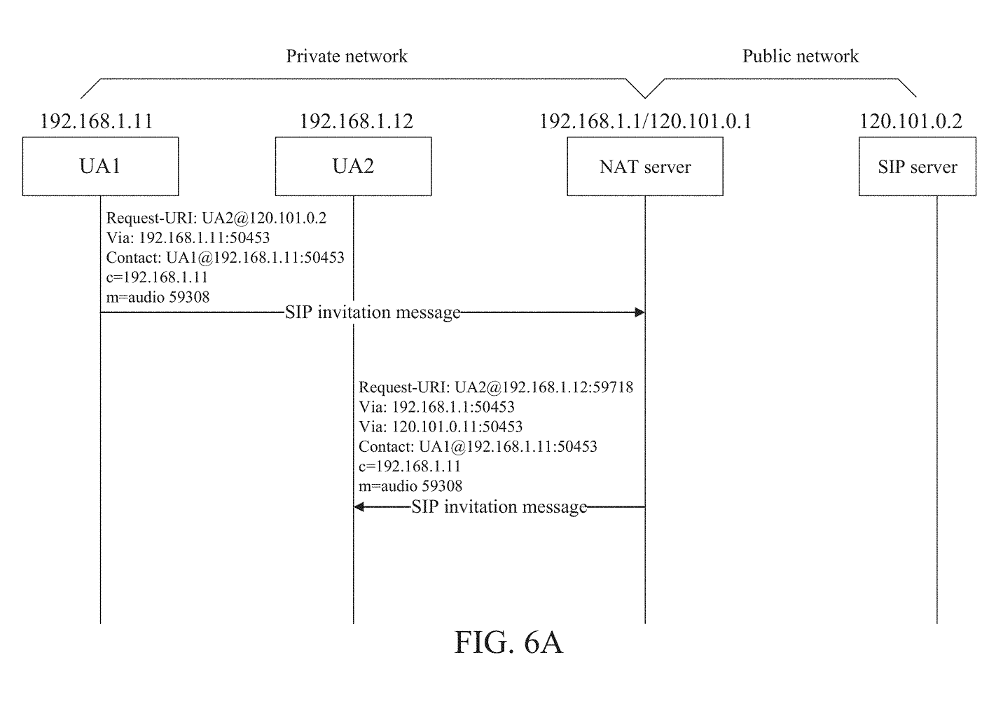

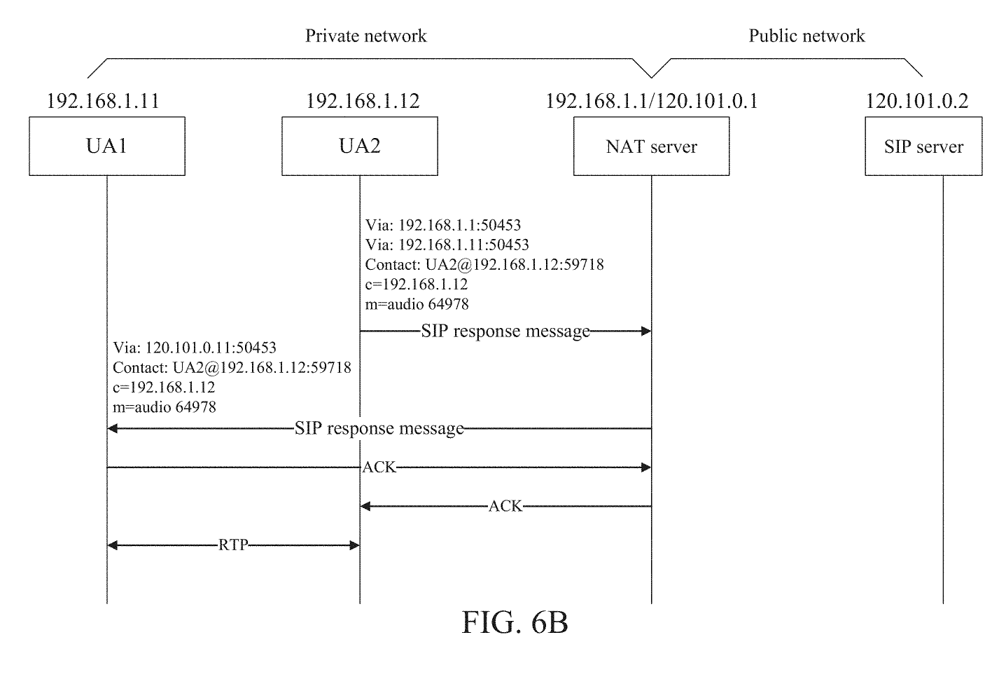

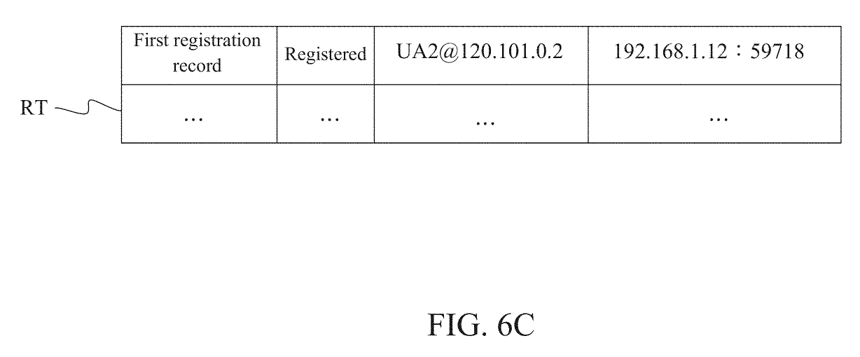

Please refer to FIG. 6A to FIG. 6C. FIG. 6A to FIG. 6B are schematic views illustrating detailed operations of a NAT server according to a sixth embodiment of the present invention, and FIG. 6C is a schematic view of an equipment registration table according to a sixth embodiment of the present invention. The sixth embodiment is similar to the fourth to the fifth embodiments in network architecture, so hardware elements identical to those of the previous embodiments will not be described again herein. The sixth embodiment is mainly intended to illustrate the operation process.

First when a first UE UA1 in a private network of the NAT server is to request a second UE UA2 to create SIP, the first UE UA1 transmits a SIP invitation message by using first public network identification information (UA2@120.101.0.2) of the second UE UA2. The SIP invitation message comprises first public network identification information (UA2@ 120.101.0.2) of the second UE and first private network RTP information (c:192.168.1.11 and m:audio 59308).

Because the equipment registration table mainly records registration relationships between equipments in the private network and a SIP server, the NAT server may determine whether the first public network identification information (UA2@120.101.0.2) is consistent with a registration record of the equipment registration table RT directly according to the equipment registration table after the SIP invitation message is received. In this embodiment, the NAT server determines that the first public network identification information (UA2@120.101.0.2) is consistent with a first registration record of the equipment registration table RT.

The NAT server may then learn from the first registration record that the second UE UA2 to which the first UE UA1 is to connect is located within a same private network as the first UE UA1. Accordingly, the NAT server modifies the first public network identification information (UA2@120.101.0.2) of the SIP invitation message into first private network identification information (UA2@192.168.1.12) directly according to the first registration record, and transmits the SIP invitation message to the second UE UA2 according to the first private network identification information (UA2@ 192.168.1.12).

After the second UE UA2 has received the SIP invitation message and agreed to create the communication, the second UE UA2 needs to inform the first UE UA1 of related information used by SIP of the second UE UA2. Specifically, the second UE UA2 transmits a SIP response message to the NAT server after receiving the SIP invitation message. The SIP response message comprises second private network RTP information (c:192.168.1.12 and m:audio 64978).

Then the NAT server receiving the SIP response message transmits the SIP response message to the first UE UA1 directly so that the first UE UA1 returns an acknowledgement to the second UE UA2 and performs real-time communication with the second UE UA2 according to the first private network RTP information (c:192.168.1.11 and m:audio 59308) and the second private network RTP information (c:192.168.1.12 and m:audio 64978).

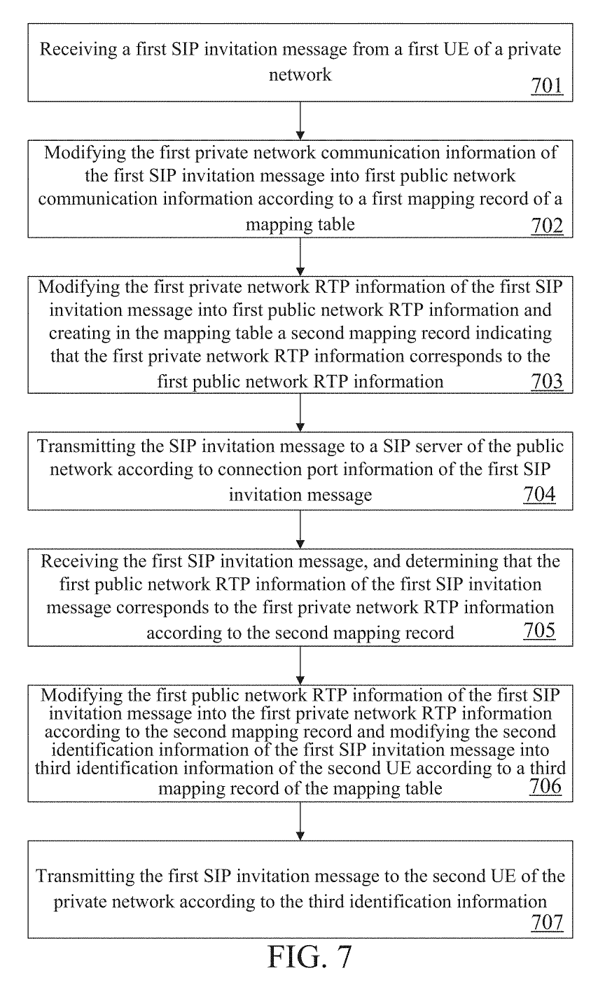

A seventh embodiment of the present invention is a NAT method, a flowchart diagram of which is shown in FIG. 7. The method of the seventh embodiment is used for a NAT server (e.g., the NAT server 1 of the aforesaid embodiments). Detailed steps of the seventh embodiment are described as follows.

First, step 701 is executed to enable the NAT server to receive a first SIP invitation message from a first UE of a private network. The first SIP invitation message comprises first private network communication information of the first UE, first identification information of a second UE and first private network RTP information. Step 702 is executed to enable the NAT server to modify the first private network communication information of the first SIP invitation message into first public network communication information according to a first mapping record of a mapping table.

Then step 703 is executed to enable the NAT server to modify the first private network RTP information of the first SIP invitation message into first public network RTP information and create in the mapping table a second mapping record indicating that the first private network RTP information corresponds to the first public network RTP information. Step 704 is executed to enable the NAT server to transmit the SIP invitation message to a SIP server of the public network according to connection port information of the first SIP invitation message.

Accordingly, the SIP server may access registration information of the second UE according to the first identification information of the SIP invitation message, modify the first identification information of the first SIP invitation message into second identification information according to the registration information, and then transmits the first SIP invitation message to the NAT server according to the second identification information. Next, step 705 is executed to enable the NAT server to receive the first SIP invitation message from the SIP server, and determine that the first public network RTP information of the first SIP invitation message corresponds to the first private network RTP information according to the second mapping record.

Step 706 is executed to enable the NAT server to modify the first public network RTP information of the first SIP invitation message into the first private network RTP information according to the second mapping record and modify the second identification information of the first SIP invitation message into third identification information of the second UE according to a third mapping record of the mapping table. At last, Step 707 is executed to enable the NAT server to transmit the first SIP invitation message to the second UE of the private network according to the third identification information so that the second UE responds to the first UE according to the first private network RTP information.

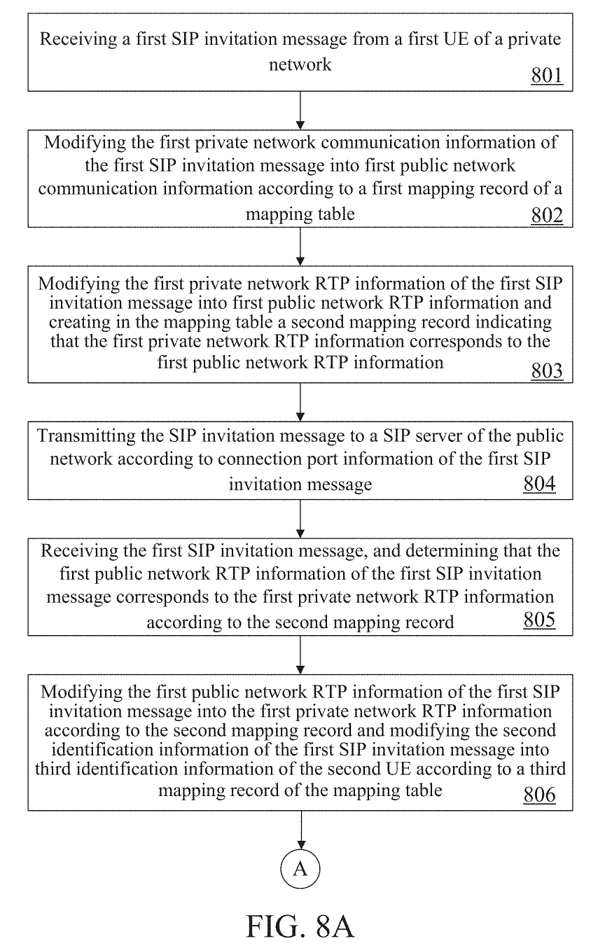

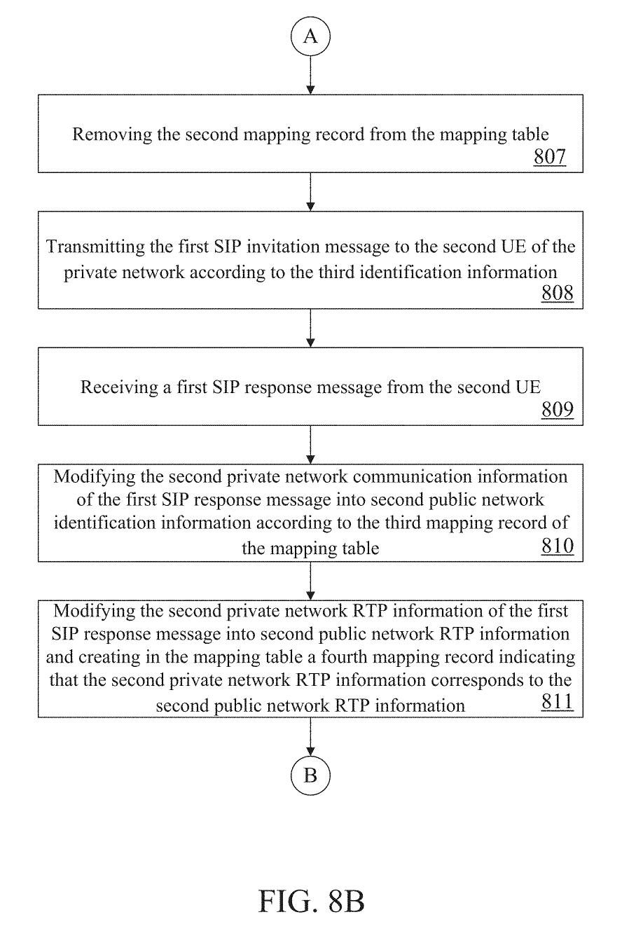

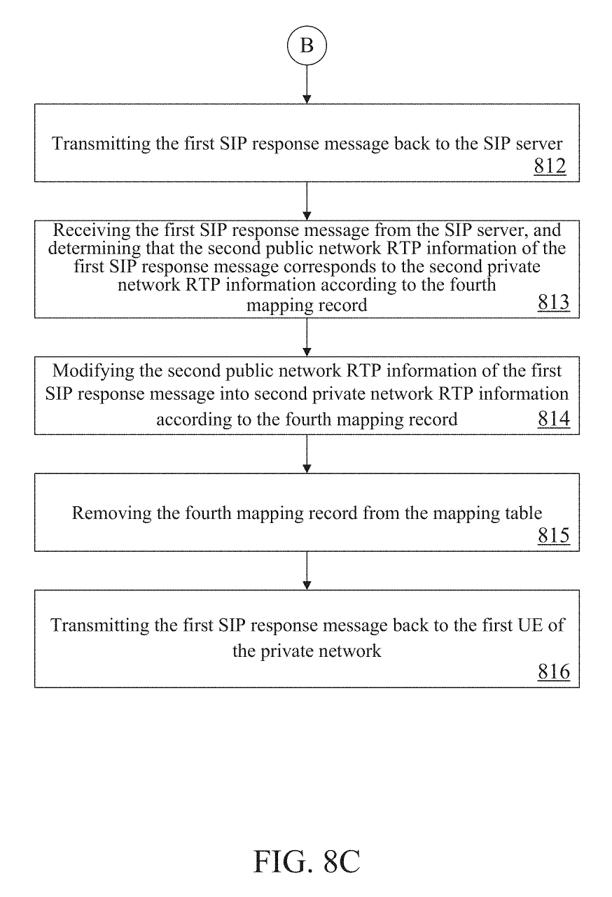

An eighth embodiment of the present invention is a NAT method, a flowchart diagram of which is shown in FIG. 8A to FIG. 8C. The method of the eighth embodiment is used for a NAT server (e.g., the NAT server 1 of the aforesaid embodiments). Detailed steps of the eighth embodiment are described as follows.

First, step 801 is executed to enable the NAT server to receive a first SIP invitation message from a first UE of a private network. The first SIP invitation message comprises first private network communication information of the first UE, first identification information of a second UE and first private network RTP information. Step 802 is executed to enable the NAT server to modify the first private network communication information of the first SIP invitation message into first public network communication information according to a first mapping record of a mapping table.

Then step 803 is executed to enable the NAT server to modify the first private network RTP information of the first SIP invitation message into first public network RTP information and create in the mapping table a second mapping record indicating that the first private network RTP information corresponds to the first public network RTP information. Step 804 is executed to enable the NAT server to transmit the SIP invitation message to a SIP server of the public network according to connection port information of the first SIP invitation message.

Accordingly, the SIP server may access registration information of the second UE according to the first identification information of the SIP invitation message, modify the first identification information of the first SIP invitation message into second identification information according to the registration information, and then transmits the first SIP invitation message to the NAT server according to the second identification information. Next, Step 805 is executed to enable the NAT server to receive the first SIP invitation message from the SIP server, and determine that the first public network RTP information of the first SIP invitation message corresponds to the first private network RTP information according to the second mapping record.

Step 806 is executed to enable the NAT server to modify the first public network RTP information of the first SIP invitation message into the first private network RTP information according to the second mapping record and modify the second identification information of the first SIP invitation message into third identification information of the second UE according to a third mapping record of the mapping table. Step 807 is executed to enable the NAT server to remove the second mapping record from the mapping table.

Step 808 is then executed to enable the NAT server to transmit the first SIP invitation message to the second UE of the private network according to the third identification information. Step 809 is executed to enable the NAT server to receive a first SIP response message from the second UE. The first SIP response message comprises second private network communication information of the second UE and second private network RTP information.

Step 810 is executed to enable the NAT server to modify the second private network communication information of the first SIP response message into second public network identification information according to the third mapping record of the mapping table. Step 811 is executed to enable the NAT server to modify the second private network RTP information of the first SIP response message into second public network RTP information and create in the mapping table a fourth mapping record indicating that the second private network RTP information corresponds to the second public network RTP information.

Next, step 812 is executed to enable the NAT server to transmit the first SIP response message back to the SIP server so that the SIP server transmits the first SIP response message back to the NAT server to which the first UE belongs. Step 813 is executed to enable the NAT server to receive the first SIP response message from the SIP server, and determine that the second public network RTP information of the first SIP response message corresponds to the second private network RTP information according to the fourth mapping record.

Step 814 is executed to enable the NAT server to modify the second public network RTP information of the first SIP response message into second private network RTP information according to the fourth mapping record. Step 815 is executed to enable the NAT server to remove the fourth mapping record from the mapping table. At last, step 816 is executed to enable the NAT server to transmit the first SIP response message back to the first UE of the private network so that the first UE returns an acknowledgement to the second UE and performs real-time communication according to the first private network RTP information and the second private network RTP information.

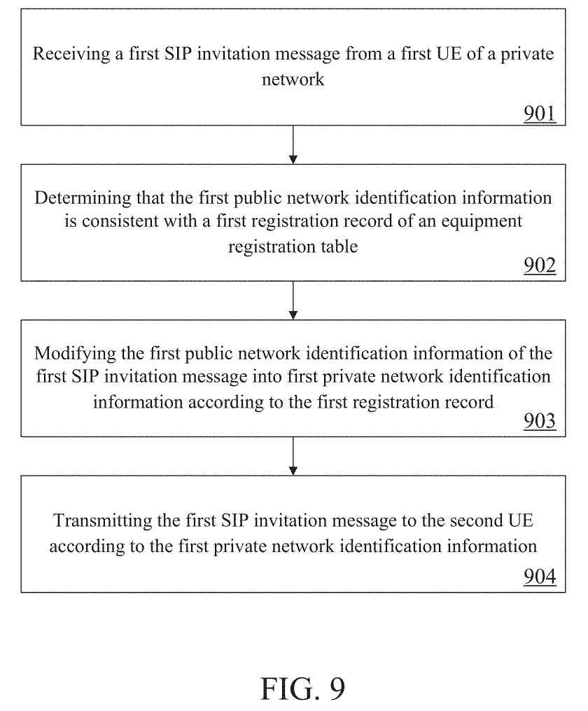

A ninth embodiment of the present invention is a NAT method, a flowchart diagram of which is shown in FIG. 9. The method of the ninth embodiment is used for a NAT server (e.g., the NAT server 2 of the aforesaid embodiments). Detailed steps of the ninth embodiment are described as follows.

First, step 901 is executed to enable the NAT server to receive a first SIP invitation message from a first UE of a private network. The first SIP invitation message comprises first private network RTP information and first public network identification information of a second UE. Step 902 is executed to enable the NAT server to determine that the first public network identification information is consistent with a first registration record of an equipment registration table.

Then step 903 is executed to enable the NAT server to modify the first public network identification information of the first SIP invitation message into first private network identification information according to the first registration record. At last, step 904 is executed to enable the NAT server to transmit the first SIP invitation message to the second UE according to the first private network identification information so that the second UE responds to the first UE according to the first private network RTP information.

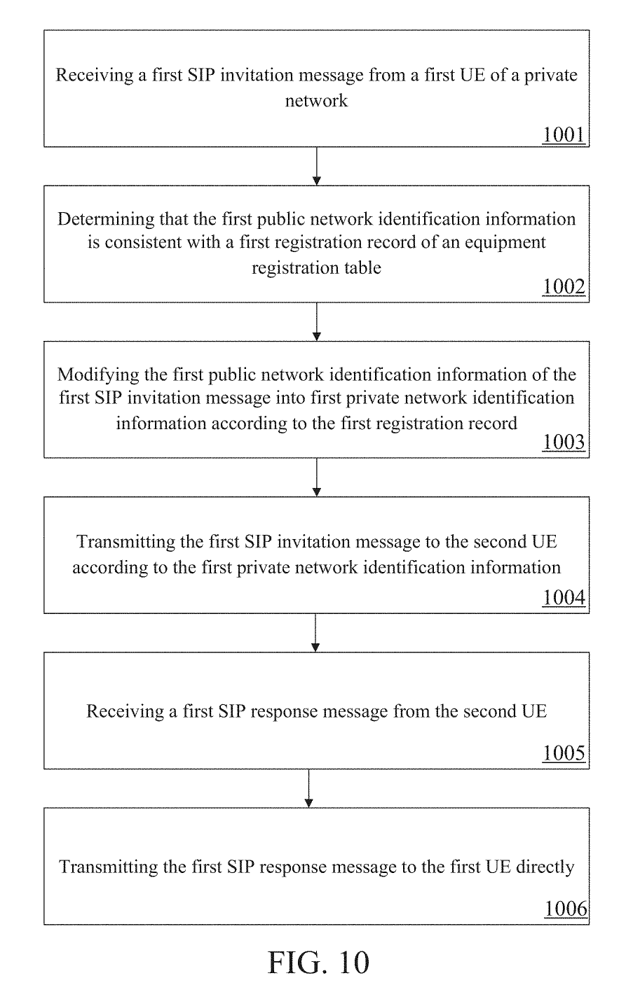

A tenth embodiment of the present invention is a NAT method, a flowchart diagram of which is shown in FIG. 10. The method of the tenth embodiment is used for a NAT server (e.g., the NAT server 2 of the aforesaid embodiments). Detailed steps of the tenth embodiment are described as follows.

First, Step 1001 is executed to enable the NAT server to receive a first SIP invitation message from a first UE of a private network. The first SIP invitation message comprises first private network RTP information and first public network identification information of a second UE. Step 1002 is executed to enable the NAT server to determine that the first public network identification information is consistent with a first registration record of an equipment registration table.

Then step 1003 is executed to enable the NAT server to modify the first public network identification information of the first SIP invitation message into first private network identification information according to the first registration record. Step 1004 is executed to enable the NAT server to transmit the first SIP invitation message to the second UE according to the first private network identification information so that the second UE responds to the first UE according to the first private network RTP information.

Step 1005 is executed to enable the NAT server to receive a first SIP response message from the second UE. The first SIP response message comprises second private network RTP information. At last, step 1006 is executed to enable the NAT server to transmit the first SIP response message to the first UE directly so that the first UE returns an acknowledgement to the second UE and performs real-time communication according to the first private network RTP information and the second private network RTP information.

According to the above descriptions, the NAT server and the NAT method thereof according to the present invention can accomplish packet routing correspondence of RTP communication services of SIP by means of mapping relationships when two UEs are located within a LAN of a same NAT server, thus improving the transmission efficiency and avoiding the burden on the backend SIP server.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network address translation (NAT) method for a NAT server, comprising:
(a) the NAT server to receiving a first Session Initiation Protocol (SIP) invitation message from a first user equipment (UE) of a private network, wherein the first SIP invitation message comprises first private network communication information of the first UE, first identification information of a second UE and first private network Real-time Transport Protocol (RTP) information;
(b) the NAT server modifying the first private network communication information of the first SIP invitation message into first public network communication information according to a first mapping record of a mapping table;
(c) the NAT server modifying the first private network RTP information of the first SIP invitation message into first public network RTP information and create in the mapping table a second mapping record indicating that the first private network RTP information corresponds to the first public network RTP information;
(d) the NAT server transmitting the SIP invitation message to a SIP server of the public network according to connection port information of the first SIP invitation message after the step (c) so that the SIP server accesses registration information of the second UE according to the first identification information of the SIP invitation message, modifies the first identification information of the first SIP invitation message into second identification information according to the registration information, and then transmits the first SIP invitation message to the NAT server according to the second identification information;
(e) the NAT server receiving the first SIP invitation message from the SIP server, and determine that the first public network RTP information of the first SIP invitation message corresponds to the first private network RTP information according to the second mapping record;
(f) the NAT server modifying the first public network RTP information of the first SIP invitation message into the first private network RTP information according to the second mapping record and modify the second identification information of the first SIP invitation message into third identification information of the second UE according to a third mapping record of the mapping table after the step (e); and
(g) the NAT server transmitting the first SIP invitation message to the second UE of the private network according to the third identification information after the step (f) so that the second UE responds to the first UE according to the first private network RTP information.

2. The NAT method according to claim 1, further comprising the following step after the step (f):
(f1) the NAT server removing the second mapping record from the mapping table.

3. The NAT method according to claim 1, further comprising the following steps after the step (g):
(h) the NAT server receiving a first SIP response message from the second UE, wherein the first SIP response message comprises second private network communication information of the second UE and second private network RTP information;
(i) the NAT server modifying the second private network communication information of the first SIP response message into second public network identification information according to the third mapping record of the mapping table;
(j) the NAT server modifying the second private network RTP information of the first SIP response message into second public network RTP information and create in the mapping table a fourth mapping record indicating that the second private network RTP information corresponds to the second public network RTP information;
(k) the NAT server transmitting the first SIP response message back to the SIP server after the step (j) so that the SIP server transmits the first SIP response message back to the NAT server to which the first UE belongs;
(l) the NAT server receiving the first SIP response message from the SIP server, and determine that the second public network RTP information of the first SIP response message corresponds to the second private network RTP information according to the fourth mapping record;
(m) the NAT server modifying the second public network RTP information of the first SIP response message into second private network RTP information according to the fourth mapping record after the step (l); and
(n) the NAT server transmitting the first SIP response message back to the first UE of the private network after the step (m) so that the first UE returns an acknowledgement to the second UE and performs real-time communication according to the first private network RTP information and the second private network RTP information.

4. The NAT method according to claim 3, further comprising the following step after the step (m):
(m1) the NAT server removing the fourth mapping record from the mapping table.

5. A network address translation (NAT) method for a NAT server, comprising:
(a) the NAT server receiving a first Session Initiation Protocol (SIP) invitation message from a first user equipment (UE) of a private network, wherein the first SIP invitation message comprises first private network Real-time Transport Protocol (RTP) information and first public network identification information of a second UE;
(b) the NAT server determining that the first public network identification information is consistent with a first registration record of an equipment registration table;
(c) the NAT server modifying the first public network identification information of the first SIP invitation message into first private network identification information according to the first registration record according to the result of the step (b); and
(d) the NAT server transmitting the first SIP invitation message to the second UE according to the first private network identification information so that the second UE responds to the first UE according to the first private network RTP information.

6. The NAT method according to claim 5, further comprising:
(e) the NAT server receiving a first SIP response message from the second UE, wherein the first SIP response message comprises second private network RTP information; and
(f) the NAT server transmitting the first SIP response message to the first UE directly so that the first UE returns an acknowledgement to the second UE and performs real-time communication according to the first private network RTP information and the second private network RTP information.

7. A network address translation (NAT) server, comprising:
a memory, storing a mapping table;
a transceiving interface; and
a processing unit;
wherein the transceiving interface is configured to receive a first Session Initiation Protocol (SIP) invitation message from a first user equipment (UE) of a private network, wherein the first SIP invitation message comprises first private network communication information of the first UE, first identification information of a second UE and first private network Real-time Transport Protocol (RTP) information;
the processing unit is configured to:
modify the first private network communication information of the first SIP invitation message into first public network communication information according to a first mapping record of the mapping table;
modify the first private network RTP information of the first SIP invitation message into first public network RTP information and create in the mapping table a second mapping record indicating that the first private network RTP information corresponds to the first public network RTP information;
transmit the SIP invitation message to a SIP server of the public network through the transceiving interface according to connection port information of the first SIP invitation message so that the SIP server accesses registration information of the second UE according to first identification information of the SIP invitation message, modifies the first identification information of the first SIP invitation message into second identification information according to the registration information, and then transmits the first SIP invitation message to the NAT server according to the second identification information;
receive the first SIP invitation message through the transceiving interface from the SIP server, and then determine that the first public network RTP information of the first SIP invitation message corresponds to the first private network RTP information according to the second mapping record;
modify the first public network RTP information of the first SIP invitation message into the first private network RTP information according to the second mapping record and modify the second identification information of the first SIP invitation message into third identification information of the second UE according to a third mapping record of the mapping table;
transmit the first SIP invitation message to the second UE of the private network through the transceiving interface according to the third identification information so that the second UE responds to the first UE according to the first private network RTP information.

8. The NAT server according to claim 7, wherein the processing unit is further configured to modify the first public network RTP information of the first SIP invitation message into the first private network RTP information and then remove the second mapping record from the mapping table.

9. The NAT server according to claim 7, wherein the transceiving interface is further configured to receive a first SIP response message from the second UE, wherein the first SIP response message comprises second private network communication information of the second UE and second private network RTP information, and the processing unit is further configured to:
modify the second private network communication information of the first SIP response message into second public network identification information according to the third mapping record of the mapping table;
modify the second private network RTP information of the first SIP response message into second public network RTP information and create in the mapping table a fourth mapping record indicating that the second private network RTP information corresponds to the second public network RTP information;
transmit the first SIP response message back to the SIP server through the transceiving interface so that the SIP server transmits the first SIP response message back to the NAT server to which the first UE belongs;
receive the first SIP response message through the transceiving interface from the SIP server, and then determine that the second public network RTP information of the first SIP response message corresponds to the second private network RTP information according to the fourth mapping record;
modify the second public network RTP information of the first SIP response message into second private network RTP information according to the fourth mapping record;
transmit the first SIP response message back to the first UE of the private network through the transceiving interface so that the first UE returns an acknowledgement to the second UE and performs real-time communication according to the first private network RTP information and the second private network RTP information.

10. The NAT server according to claim 9, wherein the processing unit is further configured to modify the second public network RTP information of the first SIP response message into the second private network RTP information and then remove the fourth mapping record from the mapping table.

11. A network address translation (NAT) server, comprising:
a memory, storing an equipment registration table;
a transceiving interface; and
a processing unit;
wherein the transceiving interface is configured to receive a first Session Initiation Protocol (SIP) invitation message from a first user equipment (UE) of a private network, wherein the first SIP invitation message comprises first private network Real-time Transport Protocol (RTP) information and first public network identification information of a second UE;
the processing unit is configured to:
determine that the first public network identification information is consistent with a first registration record of the equipment registration table;
modify the first public network identification information of the first SIP invitation message into first private network identification information according to the first registration record;
transmit the first SIP invitation message to the second UE through the transceiving interface according to the first private network identification information so that the second UE responds to the first UE according to the first private network RTP information.

12. The NAT server according to claim 11, wherein the transceiving interface is further configured to:
receive a first SIP response message from the second UE, wherein the first SIP response message comprises second private network RTP information, the processing unit is further configured to:
transmit the first SIP response message to the first UE directly so that the first UE returns an acknowledgement to the second UE and performs real-time communication according to the first private network RTP information and the second private network RTP information.
